(19) United States
(12) Patent Application Publication
(10) Pub. No.: US 2022/0145800 A1
(43) Pub. Date: May 12, 2022

(54) Compact Airfoil Bleed-Air Re-circulation Heat Exchanger

(71) Applicant: Solar Turbines Incorporated, San Diego, CA (US)

(72) Inventors: James B. Peffley, Santee, CA (US); Ashley M. Vega, San Diego, CA (US); Jiang Luo, San Diego, CA (US); Richard A. Rogers, San Diego, CA (US)

(73) Assignee: Solar Turbines Incorporated, San Diego, CA (US)

(21) Appl. No.: 17/094,034

(22) Filed: Nov. 10, 2020

(51) Int. Cl. F02C 7/14; F01D 5/18

(52) U.S. Cl. CPC F02C 7/14; F01D 5/187; F05D 2260/213; F05D 2250/231; F05D 2240/35

(57) ABSTRACT

A compact heat exchanger is disclosed for re-circulating bleed air from a combustor into an inlet and/or exhaust of a gas turbine engine. In an embodiment, the heat exchanger may comprise a plurality of airfoils with internal passages that receive bleed air. The bleed air may be forced through outlets in one or a plurality of concentric passages from the internal passage of each airfoil to an internal cavity of each airfoil, and out of micro-holes within a trailing surface of the airfoil. This enables bleed air to be mixed with gas flowing through the airfoils, in close proximity to the compressor or turbine of the gas turbine engine, while providing acoustic noise suppression and low thermal mixing stratification.

### TECHNICAL FIELD

The embodiments described herein are generally directed to re-circulation of bleed air, and, more particularly, to a compact airfoil bleed-air re-circulation heat exchanger that exhibits, for example, low thermal mixing stratification and noise suppression via internal acoustic trapping.

### BACKGROUND

Current industrial gas turbine engines utilize a bleed-air circuit (i.e., a port or tap that removes air from the combustor) to maintain a constant, optimum, low-emissions, combustion environment, across the load and prevailing ambient range. The operable or serviceable low-emissions load range is often limited in capability, due to the prevailing ambient temperature. The bleed air that gets exhausted has passed through the compressor, and consequently, has a higher pressure and temperature than the ambient conditions.

Most bleed-air circuits exhaust the bleed air back into the ambient environment via an exhaust stack or collector. However, instead of routing the bleed air to the exhaust, the bleed air may be recirculated upstream of the compressor, and mixed with ambient air at the inlet of the gas turbine engine to pre-heat the inlet air to a desired temperature. This can create an advantageous thermodynamic cycle effect by increasing the temperature of the inlet air into the combustor. This significantly extends the low-emissions load range of the gas turbine engine into lower loads and lower ambient conditions. Simultaneously, the heat rate of the gas turbine engine is improved by virtue of reduced fuel burn and reduced CO₂ emissions.

However, when mixing bleed air back into the inlet air, the hot bleed air must mix well enough to meet acceptable thermal stratification levels. In addition, the bleed air must exhibit a low acoustic noise signature prior to entering the compressor. This often drives heat exchanger designs that are largely inefficient in both their aerodynamic blockage and heat exchange capability. For example, these heat exchangers need to be placed five to ten inlet diameters upstream of the gas turbine engine to ensure that thermal stratification requirements are satisfied. The resulting large heat exchangers are not capable of fitting inside standard engine packages, and often result in large variations in performance and capability.

For example, U.S. Patent Publication No. 2017/0292456 A1 discloses a heat exchanger with multiple piccolo pipes. The pipes traverse the flow path of inlet air with nozzles that comprise central hollow tubes, surrounded by a layer of wire mesh, surrounded by an outer tube. Bleed air passes through an inner outlet in the central hollow tube, through the wire mesh, and out an outer outlet in the outer tube, to mix with the inlet air. However, such a heat exchanger must be installed at a significant distance from the compressor inlet and results in significant parasitic pressure loss.

The present disclosure is directed toward overcoming one or more of these and other problems discovered by the inventors.

### SUMMARY

In an embodiment, a heat exchanger is disclosed that comprises: one or more airfoils with a leading edge and a trailing edge, and a longitudinal axis through the leading edge and the trailing edge, wherein each of the one or more airfoils comprises at least one passage within an internal cavity of the airfoil, wherein the at least one passage extends along a transverse axis that is orthogonal to the longitudinal axis, wherein the at least one passage comprises a hollow cylinder with one or more outlets that extend radially through a wall of the hollow cylinder, and a plurality of micro-holes through a wall of the airfoil to fluidly connect the internal cavity of the airfoil to an exterior of the airfoil.

In an embodiment, a system is disclosed that comprises: a compressor; a heat exchanger comprising a plurality of airfoils extending across an inlet to the compressor, wherein each of the plurality of airfoils comprises a leading edge and a trailing edge, and a longitudinal axis through the leading edge and the trailing edge, and wherein each of the plurality of airfoils further comprises a plurality of passages within the airfoil, wherein each of the plurality of passages extend along a transverse axis that is orthogonal to the longitudinal axis, and wherein each of the plurality of passages is in fluid communication with at least one adjacent one of the plurality of passages via at least one outlet, one or more serpentine flow paths that extend through the plurality of passages via the outlets to an internal cavity of the airfoil, and a plurality of micro-holes through a wall of the airfoil to fluidly connect the internal cavity of the airfoil to the inlet to the compressor; a combustor that is downstream from the compressor; and a bleed-air circuit that is configured to supply bleed air from the combustor to at least one of the plurality of passages in each of the plurality of airfoils.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a schematic diagram of a gas turbine engine, according to an embodiment;

FIG. 2 illustrates a schematic diagram of a gas turbine engine, according to an alternative embodiment;

FIG. 3 illustrates a perspective view of an installed heat exchanger, according to an embodiment;

FIG. 4 illustrates a perspective view of an installed heat exchanger with the header frame removed, according to an embodiment;

FIG. 5 illustrates a cross-sectional view of an airfoil, according to an embodiment;

FIG. 6 illustrates a cross-sectional perspective view of an airfoil, according to an embodiment;

FIG. 7 illustrates a cross-sectional perspective view of an airfoil, according to an alternative embodiment; and

FIG. 8 illustrates a cross-sectional view of an airfoil, according to an alternative embodiment.

### DETAILED DESCRIPTION

The detailed description set forth below, in connection with the accompanying figures, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

For clarity and ease of explanation, some surfaces and details may be omitted in the present description and figures. In addition, references herein to “upstream” and “downstream” are relative to the flow direction of the primary gas (e.g., air) used in the combustion process, unless specified otherwise. It should be understood that “upstream” refers to a position that is closer to the source of the primary gas or a direction towards the source of the primary gas, and “downstream” refers to a position that is farther from the source of the primary gas or a direction that is away from the source of the primary gas.

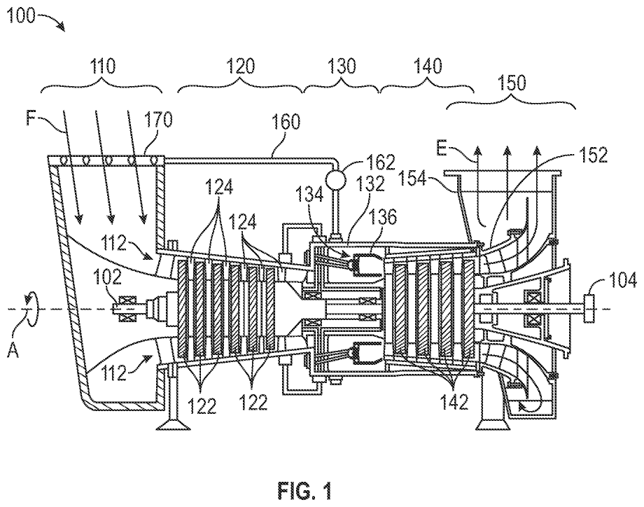

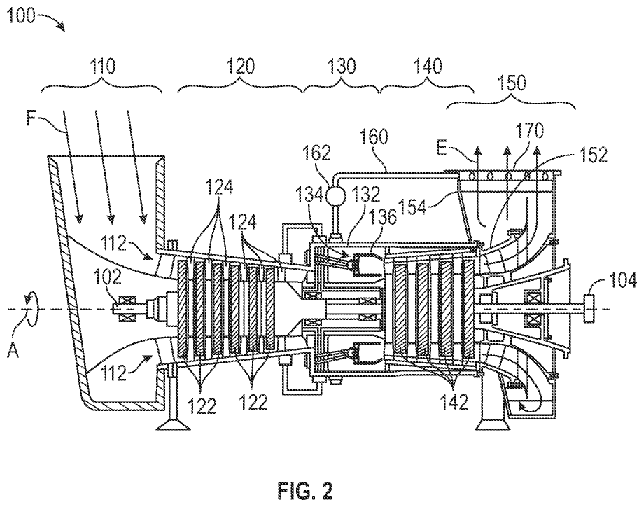

FIGS. 1 and 2 illustrate a schematic diagram of a gas turbine engine 100, according to alternative embodiments. Gas turbine engine 100 comprises a shaft 102 with a central assembly axis A. A number of other components of gas turbine engine 100 are concentric with assembly axis A.

In an embodiment, gas turbine engine 100 comprises, from an upstream end to a downstream end, an inlet 110, a compressor 120, a combustor 130, a turbine 140, and an exhaust outlet 150. In addition, the downstream end of gas turbine engine 100 may comprise a power output coupling 104. One or more, including potentially all, of these components of gas turbine engine 100 may be made from stainless steel and/or durable, high-temperature materials known as “superalloys.” A superalloy is an alloy that exhibits excellent mechanical strength and creep resistance at high temperatures, good surface stability, and corrosion and oxidation resistance. Examples of superalloys include, without limitation, Hastelloy, Inconel, Waspaloy, Rene alloys, Haynes alloys, Incoloy, MP98T, TMS alloys, and CMSX single crystal alloys.

Inlet 110 may funnel a working fluid F (e.g., a gas, such as air) into an annular flow path 112 around assembly axis A. Working fluid F flows through inlet 110 into compressor 120. While working fluid F is illustrated as flowing into inlet 110 from a particular direction and at an angle that is substantially orthogonal to assembly axis A, it should be understood that inlet 110 may be configured to receive working fluid F from any direction and at any angle that is appropriate for the particular application of gas turbine engine 100.

Compressor 120 may comprise a series of compressor rotor assemblies 122 and stator assemblies 124. Each compressor rotor assembly 122 may comprise a rotor disk that is circumferentially populated with a plurality of rotor blades. The rotor blades in a rotor disk are axially separated from the rotor blades in an adjacent disk by a stator assembly 124. Compressor 120 compresses working fluid F through a series of stages corresponding to each compressor rotor assembly 122. The compressed working fluid F then flows from compressor 120 into combustor 130.

Combustor 130 may comprise a combustor case 132 housing one or more, and generally a plurality of, fuel injectors 134. In an embodiment with a plurality of fuel injectors 134, fuel injectors 134 may be arranged circumferentially around assembly axis A within combustor case 132 at equidistant intervals. Combustor case 132 diffuses working fluid F, and fuel injector(s) 134 inject fuel into working fluid F. This injected fuel is ignited to produce a combustion reaction in one or more combustion chambers 136. The combusting fuel-gas mixture drives turbine 140.

Turbine 140 may comprise one or more turbine rotor assemblies 142. As in compressor 120, each turbine rotor assembly 142 may correspond to one of a series of stages. Turbine 140 extracts energy from the combusting fuel-gas mixture as it passes through each stage of the one or more turbine rotor assemblies 142. The energy extracted by turbine 140 may be transferred (e.g., to an external system) via power output coupling 104.

The exhaust E from turbine 140 may flow into exhaust outlet 150. Exhaust outlet 150 may comprise an exhaust diffuser 152, which diffuses exhaust E, and an exhaust collector 154 which collects, redirects, and outputs exhaust E. It should be understood that exhaust E, output by exhaust collector 154, may be further processed, for example, to reduce harmful emissions, recover heat, and/or the like. In addition, while exhaust E is illustrated as flowing out of exhaust outlet 150 in a specific direction and at an angle that is substantially orthogonal to assembly axis A, it should be understood that exhaust outlet 150 may be configured to output exhaust E towards any direction and at any angle that is appropriate for the particular application of gas turbine engine 100.

In an embodiment, gas turbine engine 100 comprises a bleed-air circuit 160 that provides a fluid passage between combustor 130 and a heat exchanger 170. For simplicity, bleed-air circuit 160 is illustrated as a tube in a particular configuration. However, it should be understood that bleed-air circuit 160 may be configured in any suitable manner, as long as bleed-air circuit 160 provides fluid communication between combustor 130 and heat exchanger 170. Specifically, bleed-air circuit 160 provides a flow path for bleed air from combustor 130 to flow into heat exchanger 170. In an embodiment, bleed-air circuit 160 comprises a bleed valve 162 that controls the amount and/or rate of bleed air that flows through bleed-air circuit 160.

As illustrated in FIG. 1, heat exchanger 170 may be positioned across the opening to inlet 110, to mix bleed air into working fluid F before it enters compressor 120. In other words, heat exchanger 170 mixes bleed air from bleed-air circuit 160 into working fluid F to preheat working fluid F. Alternatively, as illustrated in FIG. 2, heat exchanger 170 may be positioned across exhaust outlet 150, to mix bleed air into exhaust E. As yet another embodiment, gas turbine engine 100 could comprise two heat exchangers 170, with the first heat exchanger 170 positioned across the opening to inlet 110, as illustrated in FIG. 1, and the second heat exchanger 170 positioned across exhaust outlet 150, as illustrated in FIG. 2. In this case, bleed air may be circulated to one or both of the first and second heat exchangers 170, via one or more valves, as appropriate during operation of gas turbine engine 100.

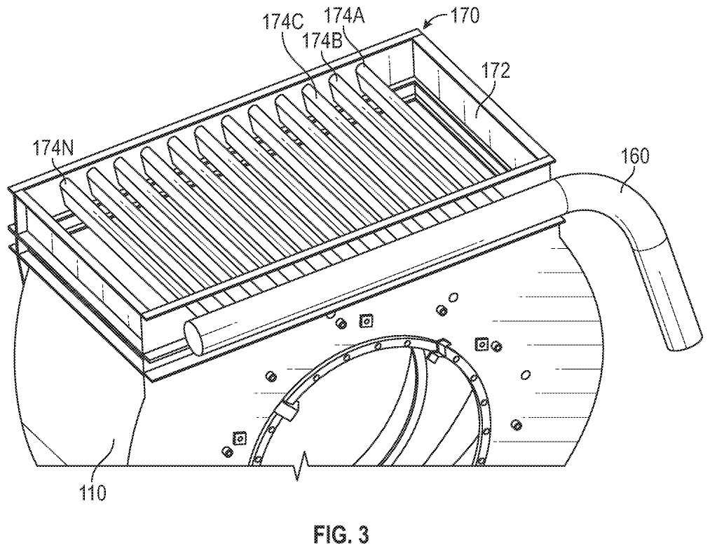

FIG. 3 illustrates a perspective view of heat exchanger 170, installed on inlet 110, according to an embodiment. As illustrated, heat exchanger 170 comprises a header frame 172 and one or more airfoils 174 extending from one side of header frame 172 to the opposite side of header frame 172. Header frame 172 is illustrated as having a rectangular profile. However, the profile of header frame 172 may take any shape, but will generally conform to the shape of the opening into inlet 110 or the opening out of exhaust outlet 150.

Header frame 172 is designed to fix airfoil(s) 174 into their respective positions. For example, in an embodiment with a plurality of airfoils 174 (e.g., airfoils 174A, 174B, 174C, . . . 174N), airfoils 174 may be spaced apart, for example, at equidistant intervals. Each airfoil 174 may be fixed to header frame 172 by any known means, including standard fastening means (e.g., bolts, screws, adhesive, etc.) and/or may be mounted through slots within header frame 172. In an alternative embodiment, header frame 172 could be omitted, in which case 174 airfoil(s) may be fixed directly to inlet 110 or exhaust outlet 150.

In the illustrated embodiment, bleed-air circuit 160 is fluidly connected to one end of each airfoil 174 on one side of heat exchanger 170, such that a fluid passage within bleed-air circuit 160 is in fluid communication with a fluid passage within each airfoil 174. Accordingly, bleed-air circuit 160 provides a flow path for bleed air to flow from combustor 130 to the interior of each airfoil 174. While FIG. 3 illustrates a specific relative arrangement of bleed-air circuit 160 and airfoils 174, it should be understood that other arrangements are possible, as long as one or more flow paths exist for bleed air from combustor 130 to flow through bleed-air circuit 160 and into a passage within each airfoil 174. For example, bleed-air circuit 160 could connect to different airfoils 174 on different sides of heat exchanger 170 via two or more flow paths (e.g., a first branching flow path that fluidly connects to a subset of every other airfoil 174 on a first side, and a second branching flow path that connects to the other subset of every other airfoil 174 on a second, opposite side).

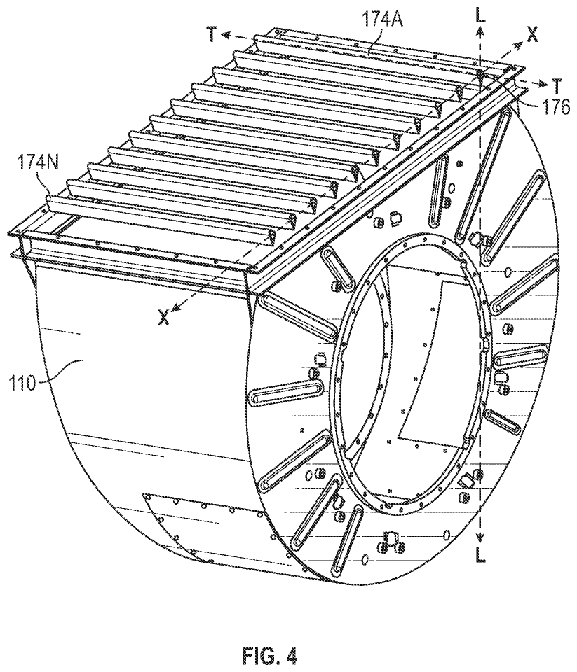

FIG. 4 illustrates a perspective view of heat exchanger 170, installed on inlet 110, with header frame 172 removed, according to an embodiment. As illustrated, a plurality of airfoils 174 are spaced apart at equidistant intervals along a lateral axis X. Each of the plurality of airfoils 174 is oriented along a longitudinal axis L that is orthogonal to lateral axis X, and comprises an opening 176, along a transverse axis T that is orthogonal to lateral axis X and longitudinal axis L, on at least one end of the respective airfoil 174. Each opening 176 is configured to receive bleed air therethrough. Specifically, each opening 176 is configured to be fluidly connected to bleed-air circuit 160, and to pass bleed air from bleed-air circuit 160 into an internal passage, which extends along transverse axis T, within its respective airfoil 174.

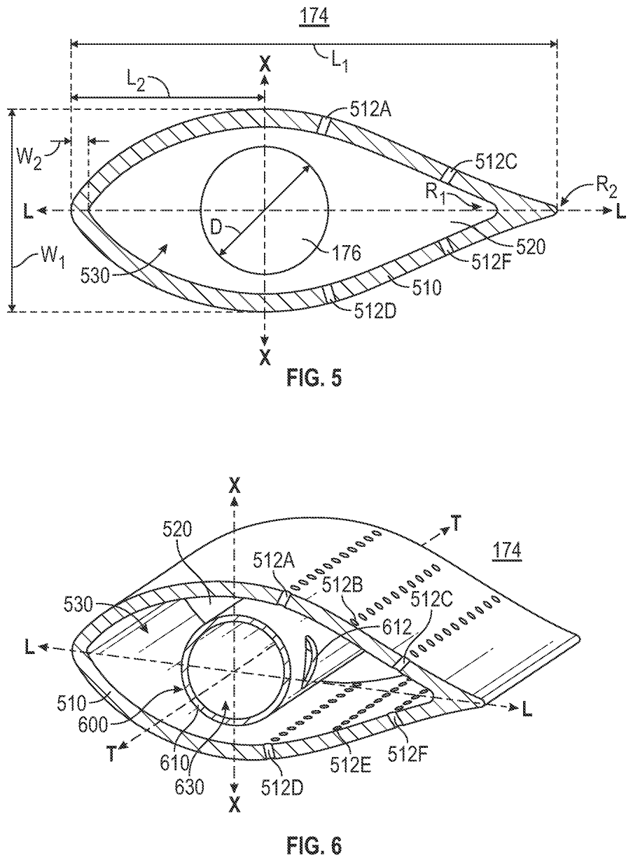

FIG. 5 illustrates a cross-sectional view of an airfoil 174, cut along a plane defined by lateral axis X and longitudinal axis L, according to an embodiment. It should be understood that, in FIG. 5, transverse axis T would extend orthogonally out of the page. As illustrated, airfoil 174 has an aerodynamic profile with a rounded leading edge (e.g., on the left in FIG. 5) and a sharper trailing edge (on the right in FIG. 5). In the illustrated embodiment, airfoil 174 is symmetric across longitudinal axis L, to aid in the uniform distribution of bleed air into inlet 110 or exhaust outlet 150. In an embodiment, each airfoil 174 is oriented such that the leading edge is upstream and the trailing edge is downstream with respect to working fluid F or exhaust E.

In an embodiment, each airfoil 174 comprises an outer wall 510 that defines the leading and trailing edges. In addition, each airfoil 174 may comprise side walls 520 on either end, along transverse axis T, that, together with outer walls 510, define an internal cavity 530. While only a first side wall 520 is illustrated in FIG. 5, it should be understood that a second side wall 520 would exist opposite the illustrated first wall 520. However, while first side wall 520 comprises opening 176, in an embodiment, the second side wall 520 would not comprise any opening 176, such that there is only one pathway into internal cavity 530. Alternatively, the second side wall 520 could comprise an opening 176 (or similar or different opening) to enable the entry of bleed air from both ends of airfoil 174 or to enable a flow path into a first end of airfoil 174, through airfoil 174, and out of a second, opposite end of airfoil 174.

As illustrated, outer wall 510 of each airfoil 174 comprises one or more micro-holes 512 that provide fluid communication between internal cavity 530 and an exterior of airfoil 174 (e.g., a flow path into inlet 110 or out of exhaust 150). As illustrated, all of micro-holes 512 may be positioned on the trailing surfaces of airfoil 174, and a subset of micro-holes 512 (e.g., micro-hole 512A or 512D) may be positioned more upstream than another subset of micro-holes 512 (e.g., micro-hole 512C or 512F). Each micro-hole 512 may be oriented orthogonally or substantially orthogonal through outer wall 510. Alternatively, each micro-hole 512 could be oriented at an angle through outer wall 510, in which case all micro-holes 512 could be oriented at the same angle or subsets of micro-holes 512 could be oriented at different angles relative to each other. In general, micro-holes 512 may be configured at any angle(s) that satisfy the desired temperature excursion. In addition, each micro-hole 512 could have the same shape (e.g., circular) and/or size (e.g., diameter), or different micro-holes 512 could have different shapes and/or sizes.

It should be understood that the length L₁ and width W₁ of airfoil 174, the length L₂ from the leading edge of airfoil 174 to the center of opening 176, the width W₂ of outer wall 510, the inner radius of curvature R₁ and outer radius of curvature R₂ of the trailing edge of outer wall 510, and the diameter D of opening 176 will depend on the particular application for which heat exchanger 170 is to be used and/or the design requirements of heat exchanger 170. As one, non-limiting example of a particular implementation of heat exchanger 170 to be used in a gas turbine engine 100, L₁ was 2.8682 inches, L₂ was 1.1416 inches, W₁ was 1.2000 inches, W₂ was 0.1000 inches, R₁ was 0.050 inches, R₂ was 0.030 inches, and D was 0.750 inches.

FIG. 6 illustrates a cross-sectional perspective view of airfoil 174, cut along a plane defined by lateral axis X and longitudinal axis L, according to an embodiment. As illustrated, a tubular passage 600 is in fluid communication with opening 176 so as to receive bleed air from bleed-air circuit 160. Passage 600 may comprise a hollow cylinder 610 that is inserted through opening 176, along transverse axis T, or which may be integral (e.g., formed as a single piece) with side wall 520 of airfoil 174. In either case, hollow cylinder 610 extends through internal cavity 530 along transverse axis T and defines an internal passageway 630 along transverse axis T. Hollow cylinder 610 may extend entirely through airfoil 174 from one end (e.g., defined by a first side wall 520) to the opposite end (e.g., defined by a second side wall 520). In this case, both ends may have an opening 176 (e.g., to allow bleed air to flow into, through, and out of internal passageway 630 along transverse axis T) or only one end may have an opening 176 (e.g., to allow bleed air to flow into but not out of internal passageway 630 except via outlet(s) 612). Alternatively, hollow cylinder 610 may extend only partially through airfoil 174 from the end with opening 176 and be closed on the opposite end, such that internal passageway 630 is capped at one end. While hollow cylinder 610 is illustrated with a circular profile in cross-section, the profile of hollow cylinder 610 could comprise other shapes in cross-section.

As illustrated, passage 600 comprises one or more outlets 612 extending radially through the wall of hollow cylinder 610. While outlet 612 is illustrated as extending along longitudinal axis L, it should be understood that outlet 612 could extend through hollow cylinder 610 in any radial direction. Regardless of radial direction, outlet 612 fluidly connects internal passageway 630 of hollow cylinder 610 to interior cavity 530 of airfoil 174.

In an embodiment, hollow cylinder 610 comprises a plurality of outlets 612. The plurality of outlets 612 may be spaced apart at equidistant intervals along transverse axis T. The plurality of outlets 612 may all be oriented in the same direction (e.g., downstream along longitudinal axis L). Alternatively, the plurality of outlets 612 may be oriented in different directions. For example, a first outlet 612 may be oriented along longitudinal axis L, and a second, consecutive, outlet 612 may be oriented orthogonally or at another angle with respect to longitudinal axis L.

Bleed air enters internal passageway 630 through opening 176 and exits internal passageway 630 through outlet(s) 612. The bleed air enters internal cavity 530 of airfoil 174 via outlet(s) 612 and exits internal cavity 530 of airfoil 174 via micro-holes 512. Micro-holes 512 may be arranged in a plurality of rows. For example, in the illustrated embodiment, micro-holes 512 are arranged in three rows (e.g., represented by micro-holes 512A, 512B, and 512C) on each side of the trailing surface of airfoil 174. Each row may be staggered with respect to its adjacent row. For example, micro-hole 512B is not aligned with micro-hole 512A along longitudinal axis L, and micro-hole 512C is not aligned with micro-hole 512B along longitudinal axis L, but, in the illustrated embodiment, micro-hole 512C is aligned with micro-hole 512A along longitudinal axis L.

Each micro-hole 512 in each row of micro-holes 512 (e.g., 512A, 512B, and 512C) may be the same shape and/or size, and may be much smaller in size than outlet(s) 612 (e.g., micro-holes 512 may have much smaller diameters than outlet(s) 612). For example, as one, non-limiting example of a particular implementation of airfoil 174, each micro-hole 512 is circular with the same diameter (e.g., 0.060 inches). Alternatively, each row of micro-holes 512 may be different in shape and/or size, and/or micro-holes 512 in a single row may differ in shape and/or size. For example, the micro-holes 512 in each row may increase in diameter as they approach the trailing edge of airfoil 174. In other words, the micro-holes 512 in rows that are more downstream (i.e., closer to the trailing edge and farther from the leading edge) may be larger in diameter than the micro-holes 512 in rows that are more upstream (i.e., farther from the trailing edge and closer to the leading edge). As one, non-limiting example of a particular implementation of airfoil 174, micro-holes 512A and 512D are 0.035 inches in diameter, micro-holes 512B and 512E are 0.060 inches in diameter, and micro-holes 512C and 512F are 0.080 inches in diameter.

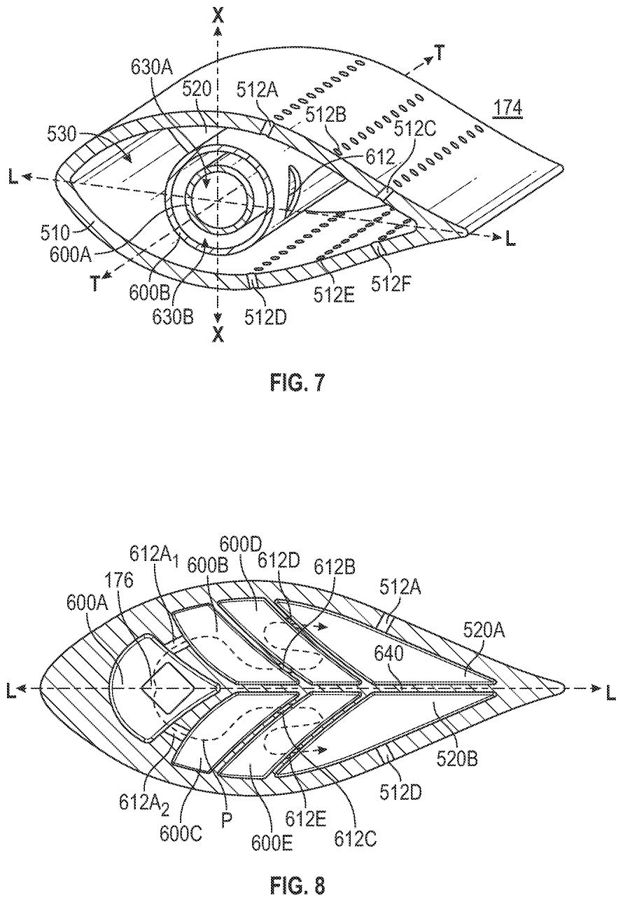

FIG. 7 illustrates a cross-sectional perspective view of airfoil 174, cut along a plane defined by lateral axis X and longitudinal axis L, according to another embodiment. The embodiment in FIG. 7 differs from the embodiment in FIG. 6 in that it comprises a plurality of concentric passages 600 to further baffle acoustic noise. While two concentric passages 600A and 600B are illustrated, airfoil 174 may comprise any number of concentric passages 600. In an embodiment, only the centermost passage 600A is in fluid communication with bleed-air circuit 160 through opening 176.

Each passage 600 may comprise a hollow cylinder 610, defining an internal passageway 630, and one or more outlets 612 extending radially through the wall of hollow cylinder 610. In an embodiment, each passage 600 comprises a plurality of outlets 612 that are spaced apart at equidistant intervals along transverse axis T. In such an embodiment, the outlets 612 in a first passage 600A may be staggered with respect to outlets 612 in a second passage 600B. In this case, outlets 612 in first passage 600A are not aligned with outlets 612 in second passage 600B along longitudinal axis L and/or transverse axis T. For example, outlets 612 in first passage 600A could be oriented at different radial angles or directions with respect to longitudinal axis L than outlets 612 in second passage 600B and/or could be located at different positions along transverse axis T than outlets 612 in second passage 600B. Thus, bleed air is forced to take a serpentine path from internal passageway 630A of central passage 600A to internal cavity 530 of airfoil 174, to thereby reduce acoustic noise. Specifically, the bleed air in internal passageway 630A radially exits an outlet 612 in hollow cylinder 610 of central passage 600A to enter internal passageway 630B defined by hollow cylinder 610 of concentric outer passage 600B. Next, the bleed air in internal passageway 630B travels along transverse axis T and exits a staggered outlet 612 in hollow cylinder 610 of concentric outer passage 600B. It should be understood that this serpentine flow path may be extended for any number of concentric passages 600, until the bleed air exits outlet(s) 612 of an outermost passage 600 to enter internal cavity 530 of airfoil 174. Then, the bleed air in internal cavity 530 of airfoil 174 exits micro-holes 512 to mix with working fluid F or exhaust E flowing across airfoils 174 of heat exchanger 170.

More generally, one or more serpentine flow paths may be provided from an internal passageway 630, which is in fluid communication with hole 176, to internal cavity 520. As used herein, the term “serpentine” refers to any non-linear flow path. Thus, a serpentine flow path may force the bleed air to pass through one or more curves before entering internal cavity 520 and exiting micro-holes 512. In an embodiment, at least one of these curve(s) may be generally U-shaped, such that bleed air may be forced in an upstream, lateral, and/or transverse direction for a portion of the flow path, while the overall flow path carries bleed air downstream.

FIG. 8 illustrates a cross-sectional view of an airfoil 174, according to an alternative embodiment. Notably, in this embodiment, passages 600 are not concentric. Rather, as illustrated, a plurality of passages 600 are stacked, and each passage 600 in the stack is in fluid communication with each axially adjacent passage 600 (i.e., adjacent along an axis that is parallel to longitudinal axis L). In addition, one or more passages 600 may be angled with respect to longitudinal axis L, such that a region of that passage 600 that is closer to longitudinal axis L is more downstream than a region of that passage 600 that is farther from longitudinal axis L.

For example, as illustrated in FIG. 8, passages 600A-600E are stacked with respect to longitudinal axis L. Passage 600A is farthest upstream and is in fluid communication with hole 176. Passages 600B and 600C are generally downstream from passage 600A and are in fluid communication with passage 600A via outlets 612A₁ and 612A₂, respectively, which may comprise micro-holes. Passages 600D and 600E are generally downstream from passages 600A-600C and are in fluid communication with passages 600B and 600C via outlets 612B and 612C, respectively. In addition, passages 600D and 600E are generally upstream from internal cavities 520A and 520B and are in fluid communication with internal cavities 520A and 520B via outlets 612D and 612E, respectively.

In the embodiment of FIG. 8, bleed air may enter passage 600A in airfoil 174 via hole 176, flow into passages 600B and 600C via outlets 612A₁ and 612A₂, respectively, then flow into passages 600D and 600E via outlets 612B and 612C, respectively, then flow into internal cavities 520A and 520B via outlets 612D and 612E, respectively, and then exit airfoil 174 via micro-holes 512. As illustrated, outlets 612, in the stack of passages 600, are staggered and passages 600B-600E are angled with respect to longitudinal axis L (e.g., such that each passage 600B-600E slants upstream as it extends from longitudinal axis L to outer walls 510). This results in a serpentine flow path P, such that the bleed air cannot flow linearly from hole 176 to internal cavities 520A and 520B. In turn, this suppresses acoustic noise from the bleed air.

Notably longitudinal wall 640, along longitudinal axis L of airfoil 174, may provide structural integrity. However, in an alternative embodiment, longitudinal wall 640 may be omitted, such that there is only one passage 600 at each level of the stack of passages 600 and only one internal cavity 520. In other words, in this alternative embodiment, passages 600B and 600C would be replaced by a single continuous passage instead of a pair of discrete passages, and passages 600D and 600E would similarly be replaced by a single continuous passage instead of a pair of discrete passages.

### INDUSTRIAL APPLICABILITY

Heat exchanger 170 may utilize bleed air from bleed-air circuit 160 to, for example, preheat working fluid F (e.g., inlet air) at inlet 110 and/or bleed heat into exhaust F at exhaust outlet 150, in a gas turbine engine 100. The use of airfoils 174 with micro-holes 512 enables heat exchanger 170 to be compact and highly scalable, relative to conventional heat exchangers, while having very high aerodynamic recovery and very low thermal stratification in a very short mixing length. Heat exchanger 170 is compact enough to fit into standard packages (e.g., gas turbine engines 100) and to be retrofitted to existing packages (e.g., gas turbine engines 100) in the field. Because of the compact design enabled by airfoils 174, heat exchanger 170 can be installed very close to the inlet (e.g., annular flow path 112) of compressor 120. This can result in much lower parasitic pressure loss than in conventional systems.

In addition, the use of micro-holes 512 and outlets 612 in one or more passages 600 enables heat exchanger 170 to have a very low acoustic noise signature, while injecting bleed air into a fluid stream. The particular pattern of micro-holes 512 may be configured to ensure or maximize uniform mixing of the two fluid streams (i.e., bleed air with inlet air or exhaust) in a very short mixing length, just upstream of compressor 120 or just downstream of turbine 140. In an embodiment, heat exchanger 170 may be positioned less than five inlet diameters upstream of compressor 120 or less than five outlet diameters downstream of turbine 140.

It should be understood that the particular number of airfoils 174, the spacing between airfoils 174, the dimensions (e.g., length L₁, L₂, W₁, W₂, R₁, R₂, and D in FIG. 5) of airfoils 174, the shape and size (e.g., diameter) of hole 176, the number of passages 600, the dimensions (e.g., diameter) of passages 600, the shapes and sizes of holes 612, the pattern of holes 612, the shapes and sizes of micro-holes 512, the pattern of micro-holes 512, and/or the like, may all depend on the particular application in which heat exchanger 170 is used.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented in a gas turbine engine, it will be appreciated that it can be implemented in various other types of machines with bleed-air recirculation from one component to another, and in various other systems and environments. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. A heat exchanger comprising:
one or more airfoils with a leading edge and a trailing edge, and a longitudinal axis through the leading edge and the trailing edge, wherein each of the one or more airfoils comprises
at least one passage within an internal cavity of the airfoil, wherein the at least one passage extends along a transverse axis that is orthogonal to the longitudinal axis, wherein the at least one passage comprises a hollow cylinder with one or more outlets that extend radially through a wall of the hollow cylinder, and
a plurality of micro-holes through a wall of the airfoil to fluidly connect the internal cavity of the airfoil to an exterior of the airfoil.

2. The heat exchanger of claim 1, wherein the one or more airfoils are a plurality of airfoils that are spaced apart from each other along a lateral axis that is orthogonal to the longitudinal axis and the transverse axis.

3. The heat exchanger of claim 2, further comprising a header frame that defines an opening, wherein the plurality of airfoils extends across the opening from one side of the header frame to an opposite side of the header frame.

4. The heat exchanger of claim 1, wherein the one or more outlets are a plurality of outlets that are spaced apart from each other along the transverse axis.

5. The heat exchanger of claim 1, wherein the at least one passage is a plurality of concentric passages, wherein each of the plurality of concentric passages comprises a hollow cylinder with one or more outlets that extend radially through a wall of the hollow cylinder.

6. The heat exchanger of claim 5, wherein the one or more outlets of each of the plurality of concentric passages are a plurality of outlets, and wherein the plurality of outlets of a first one of the plurality of concentric passages are staggered with respect to the plurality of outlets of a second one of the plurality of concentric passages that is radially adjacent to the first concentric passage.

7. The heat exchanger of claim 6, wherein the staggering comprises different positions along the transverse axis.

8. The heat exchanger of claim 6, wherein the staggering comprises different radial directions.

9. The heat exchanger of claim 1, wherein each of the one or more airfoils is symmetric across the longitudinal axis.

10. The heat exchanger of claim 1, wherein the plurality of micro-holes comprises a plurality of rows of micro-holes, wherein each of the plurality of rows of micro-holes extend parallel to the transverse axis.

11. The heat exchanger of claim 10, wherein each of the plurality of rows is staggered with respect to each adjacent one of the plurality of rows.

12. The heat exchanger of claim 10, wherein, for each of the one or more airfoils, each of the plurality of rows of micro-holes extends through a trailing surface of the airfoil.

13. The heat exchanger of claim 10, wherein all of the plurality of micro-holes have identical diameters.

14. The heat exchanger of claim 10, wherein each of the plurality of rows of micro-holes comprises micro-holes with different diameters than any of the other plurality of rows of micro-holes.

15. The heat exchanger of claim 14, wherein, for each of the one or more airfoils, the micro-holes, in rows that are closer to the trailing edge of the airfoil, have larger diameters than the micro-holes in rows that are farther from the trailing edge of the airfoil.

16. A gas turbine engine comprising:
the heat exchanger of claim 1;
a combustor; and
a bleed-air circuit in fluid communication with the combustor and the at least one passage in each of the one or more airfoils.

17. The gas turbine engine of claim 16, further comprising a compressor that is upstream from the combustor, wherein the heat exchanger is positioned across an inlet to the compressor.

18. The gas turbine engine of claim 16, further comprising a turbine downstream from the combustor, wherein the heat exchanger is positioned across an exhaust outlet downstream from the turbine.

19. The gas turbine engine of claim 16, wherein the trailing edge of each of the one or more airfoils is downstream from the leading edge of each of the one or more airfoils.

20. A system comprising:
a compressor;
a heat exchanger comprising
a plurality of airfoils extending across an inlet to the compressor, wherein each of the plurality of airfoils comprises a leading edge and a trailing edge, and a longitudinal axis through the leading edge and the trailing edge, and wherein each of the plurality of airfoils further comprises
a plurality of passages within the airfoil, wherein each of the plurality of passages extend along a transverse axis that is orthogonal to the longitudinal axis, and wherein each of the plurality of passages is in fluid communication with at least one adjacent one of the plurality of passages via at least one outlet,
one or more serpentine flow paths that extend through the plurality of passages via the outlets to an internal cavity of the airfoil, and
a plurality of micro-holes through a wall of the airfoil to fluidly connect the internal cavity of the airfoil to the inlet to the compressor;
a combustor that is downstream from the compressor; and
a bleed-air circuit that is configured to supply bleed air from the combustor to at least one of the plurality of passages in each of the plurality of airfoils.
